(19) United States
(12) Patent Application Publication
(10) Pub. No.: US 2009/0003381 A1
(43) Pub. Date: Jan. 1, 2009

(54) Method and Apparatus for Providing Protocol Translation in Support of IMS Services

(76) Inventors: John H. Shamilian, Tinton Falls, NJ (US); Thomas L. Wood, Colts Neck, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/770,533

(22) Filed: Jun. 28, 2007

(51) Int. Cl. H04J 3/22

(52) U.S. Cl. 370/467

(57) ABSTRACT

The invention includes a method and apparatus for exchanging messages between user devices served by a premises gateway and components of a core IMS network. A method for propagating messages toward a core IMS network includes receiving, at a premises gateway, a message from a user device that is intended for the core IMS network and is formatted according to a first protocol, identifying the first protocol according to which the received message is formatted, translating the message from being formatted according to the first protocol to being formatted according to a second protocol, and propagating the message formatted according to the second protocol toward the core IMS network. A method for propagating messages toward to a user device includes receiving, at a premises gateway, a message from the core IMS network that is intended for a user device served by the premises gateway and is formatted according to a first protocol, identifying a second protocol associated with the user device for which the received message is intended, translating the message from being formatted according to the first protocol to being formatted according to a second protocol, and propagating the message formatted according to the second protocol toward the user device.

### FIELD OF THE INVENTION

The invention relates to the field of communication networks and, more specifically, to signaling in Internet Protocol (IP) Multimedia Subsystem (IMS) networks.

### BACKGROUND OF THE INVENTION

Internet Protocol (IP) Multimedia Subsystem (IMS) is an architectural framework for delivering IP multimedia services to end users. For example, a core IMS network may deliver services such as voice services (e.g., VoIP service, push-to-talk service, and the like), data services, video services, and the like to user devices. Disadvantageously, user devices attempting to access IP multimedia services from IMS networks may support many different clients and client models, thereby requiring the core IMS network to support many different clients and client models to ensure that all commercially available user devices can access the core IMS network. Furthermore, in existing core IMS networks, user devices have visibility at least into the edge of the core IMS network, thereby enabling malicious users to attack the core IMS network.

### SUMMARY OF THE INVENTION

Various deficiencies in the prior art are addressed through the invention of a method and apparatus for exchanging messages between user devices served by a premises gateway and components of a core IMS network. The present invention perform protocol translation functions for translating between access protocols used by user devices served by the premises gateway and a network protocol used by the core IMS network.

A method for propagating messages to a core IMS network includes receiving, at a premises gateway, a message from a user device served by the premise gateway, wherein the message is the intended for the core IMS network and is formatted according to a first protocol, identifying the first protocol according to which the received message is formatted, translating the message from being formatted according to the first protocol to being formatted according to a second protocol, and propagating the message formatted according to the second protocol toward the core IMS network.

A method for propagating messages from a core IMS network to a user device includes receiving, at a premises gateway, a message from a component of the core IMS network, wherein the message is intended for a user device served by the premises gateway and is formatted according to a first protocol; identifying a second protocol associated with the user device for which the received message is intended, translating the message from being formatted according to the first protocol to being formatted according to a second protocol, and propagating the message formatted according to the second protocol toward the user device. In one embodiment, a message propagated from the core IMS network to a user device may be translated in a secure manner, such as by translating the message in a manner for hiding addressing and port numbering of components of the core IMS network from the user device.

### BRIEF DESCRIPTION OF THE DRAWINGS

The teachings of the present invention can be readily understood by considering the following detailed description in conjunction with the accompanying drawings, in which:

FIG. 1 depicts high-level block diagram of a communication network;

FIG. 2 depicts a method according to one embodiment of the present invention;

FIG. 3 depicts a method according to one embodiment of the present invention; and

FIG. 4 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention provides protocol translation functions enabling translation between access protocols and a normalized network protocol. Specifically, the present invention adapts a premises gateway to perform protocol translation between access protocols and a normalized network protocol. By adapting a premises gateway to perform protocol translation, the present invention presents core IMS networks from having to support many different access protocols. Furthermore, by adapting a premises gateway to perform protocol translation in a manner for hiding certain details of the core IMS network from user devices, the present invention prevents end users from having visibility into the core IMS network, thereby preventing malicious users from attacking the core IMS network.

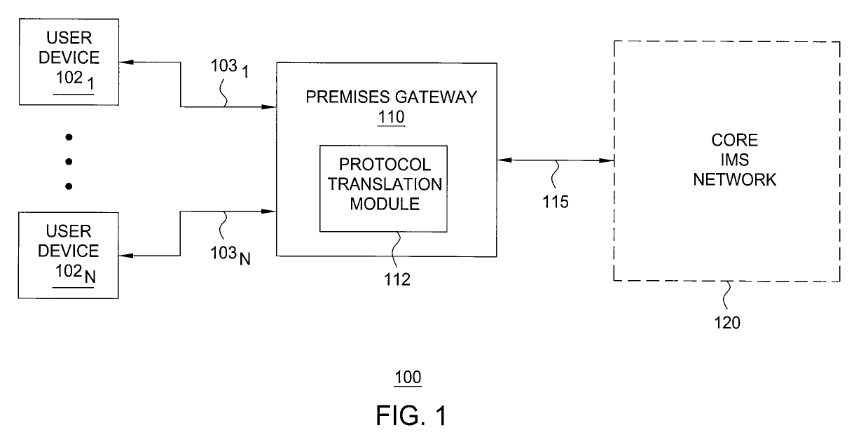

FIG. 1 depicts a high-level block diagram of a communication network. Specifically, communication network 100 includes a plurality of user devices (UDs) 102₁-102_{N} (collectively, UDs 102), a premises gateway (PG) 110, and a core network (CN) 120. The UTs 102₁-102_{N} communicate with PG 110 using respective communication paths (CPs) 103₁-103_{N} (collectively, CPs 103). The PG 110 communicates with CN 120 using a communication path (CP) 115. The UDs 102 include user terminals which may be communicatively coupled to PG 110. The PG 110 functions as an access point by which UDs 102 access CN 120. The CN 120 is an IMS-based network supporting IMS functions and services.

The CN 120 provides IMS functions, such as transport functions, control functions (e.g., connection control functions, session control functions, and the like), applications functions, services functions, and the like, as well as various combinations thereof. The CN 120 may include gateways to circuit-switched and packet-switched networks (including access and core networks), such as access network gateways, border gateways, media gateways, signaling gateways, and the like. The CN 120 may include control functions, such as call-session control functions (e.g., proxy-CSCFs, serving-CSCFs, interrogating-CSCFs), media gateway control functions (MGCFs), breakout gateway control functions (BGCFs), policy decision functions (PDFs), and the like. The CN 120 may provide applications/services, such as home subscriber servers (HSSs), media servers, application servers, and the like. CN 120 may support fewer or more such IMS functions and services.

The CN 120 supports interfaces to other networks, such as circuit switched networks (e.g., the Public Switched Telephone Network (PSTN), Public Land Mobile Networks (PLMNs), and the like), packet switching networks (e.g., IPv4 networks, IPv6 networks, and the like), various third-party networks, and the like as well as various combinations thereof. The interfaces to such other networks may be supported using different gateways. For example, signaling gateways (SGWs) and media gateways (MGWs) may provide interfaces between the IMS-based core network and PSTN/PLMN networks, and border gateways (BGs) may provide interfaces between the IMS-based core network and packet switching networks (e.g., IPv4 networks, IPv6 networks, and the like).

The CN 120 supports numerous different access network technologies. Thus, CP 115 may be supported using access network technology adapted for interfacing with CN 120. For example, CP 115 may be supported using fixed access networks (e.g., an Ethernets, cable networks, Digital Subscriber Line (DSL) networks, and the like), mobile access networks (e.g., Global System for Mobile (GSM) networks, General Packet Radio Service (GPRS) networks, Code Division Multiple Access-2000 (CDMA2000) networks, Wideband-CDMA (WCDMA) networks, and the like), wireless access networks (e.g., wireless local area networks (WLANs), Worldwide Interoperability for Microwave Access (WiMAX) networks, and the like), and the like, as well as various combinations thereof.

The CN 120 supports IP multimedia services, such as voice services, data services, video services, multimedia services, and the like, as well as various combinations thereof. For example, CN 120 may support services such as voice calls, voice conferencing, video calls, video conferencing, streaming video, presence services, instant messaging, unified messaging (e.g., voicemail, email, fax, and the like), multimedia calls, multimedia conferencing, multimedia advertising, multiparty gaming, push services (e.g., push-to-talk, push-to-view, push-to-video, and the like), IPTV, intercom services, interactive voice response, group management services, account management services (e.g., for user profiles, payments, and the like), and the like, as well as various combinations thereof. The services supported by CN 120 are accessed by UDs 102 via PG 110.

The PG 110, which is deployed at a customer location, e.g., a residential location, a business location, an enterprise location, and the like, functions as a gateway between UDs 102 and CN 120. For example, PG 110 may be a router, a gateway, an IPBX, and the like. The UDs 102 and CN 120 exchange messages by which UDs 102 request services from CN 120, and by which CN 120 responds to service requests from UDs 102. For example, such service requests may include a request to establish a voice connection with another user device, a request to view a video clip, and the like. For example, such service responses may include a signaling message provided in response to a request to view a video clip (e.g., an RTP session establishment message), and the like. The messages may include any messages which may be exchanged between UDs 102 and CN 120.

As described herein, PG 110 is adapted to perform protocol translation for messages exchanged between UDs 102 and CN 120. Specifically, PG 110 performs protocol translation between access protocols supported by UDs 102 (i.e., access protocols utilized for communications between UDs 102 and PG 110 via CPs 103) and a network protocol (or protocols) supported by CN 120 (i.e., network protocol(s) utilized for communications between CN 120 and PG 110 via CP 115). For messages initiated from UDs 102 that are intended for CN 120, PG 110 translates messages from the format of the access protocol to the format of the network protocol. For messages initiated from CN 120 that are intended for UDs 102, PG 110 translates messages from the format of the network protocol to the format of the access protocol.

The access protocols include any protocols which may be supported by UDs 102 which access CN 120. For example, access protocols may include protocols such as Megaco/H.248, Simple Gateway Control Protocol (SGCP), Skinny Client Control Protocol (SCCP), Media Gateway Control Protocol (MGCP), proprietary versions of the Session Initiation Protocol (SIP), proprietary version of Hypertext Transfer Protocol (HTTP), and the like. The network protocol is a protocol supported by CN 120 (i.e., a normalized SIP protocol used for communications between components of a core IMS network). The access protocols and network protocol may support user traffic, control traffic, and the like, as well as various combinations thereof.

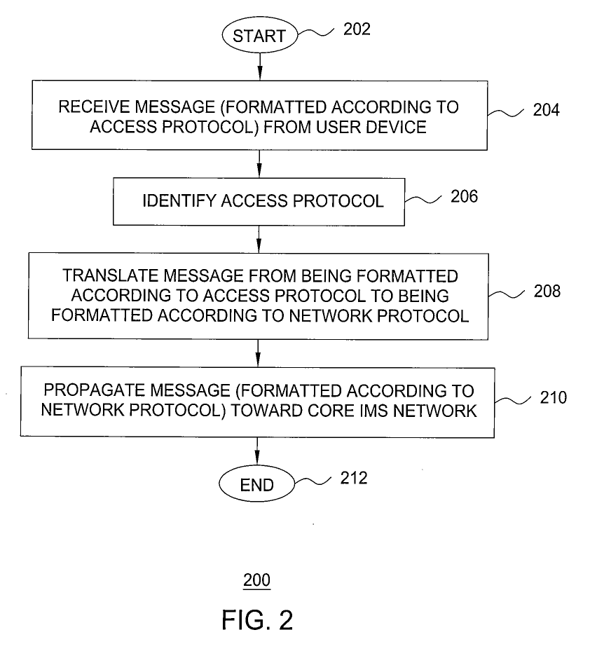

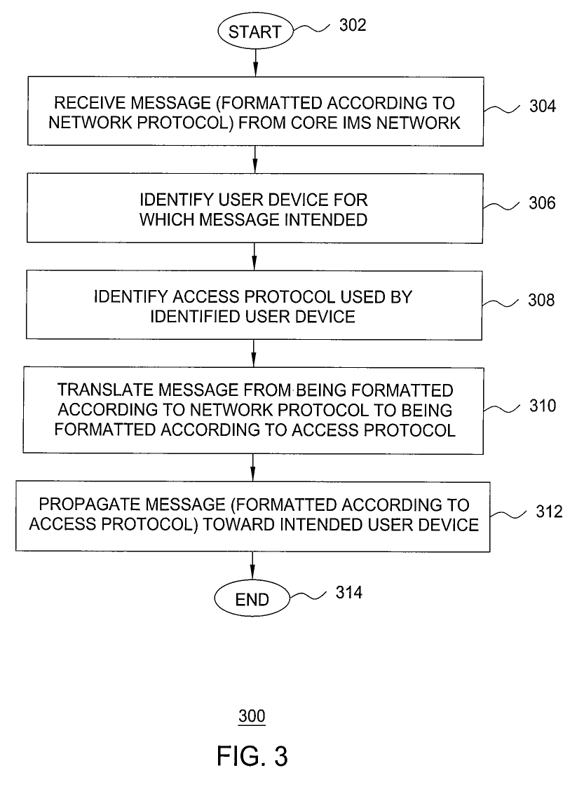

As depicted in FIG. 1, PG 110 provides protocol translation functions using a protocol translation module 112. The protocol translation module performs protocol translations by reading and rewriting header messages. The protocol translation module 112 is adapted to perform protocol translations in a secure manner (i.e., in a manner that hides core IMS network information from UDs 102). In one embodiment, for example, protocol translation module 112 performs protocol translation in a manner that hides addressing and port numbering of components of the core IMS network from the UDs 102. The operation of PG 110 in providing protocol translation functions may be better understood with respect to FIG. 2 and FIG. 3.

FIG. 2 depicts a method according to one embodiment of the present invention. Specifically, method 200 of FIG. 2 includes a method for translating a message from an access protocol to a network protocol. Although depicted and described as being performed serially, at least a portion of the steps of method 200 of FIG. 2 may be performed contemporaneously, or in a different order than depicted and described with respect to FIG. 2. The method 200 begins at step 202 and proceeds to step 204.

At step 204, a message is received. The message is received at a premises gateway from a user device served by the premises gateway. The received message is formatted according to an access protocol. The access protocol may be any access protocol, such as Megaco/H.248, SGCP, SCCP, MGCP, proprietary versions of SIP, proprietary versions of HTTP, and the like.

At step 206, the access protocol according to which the received message is formatted is identified. The s protocol according to which the received message is formatted may be identified in a number of different ways.

In one embodiment, the access protocol of the received message may be identified based on the user device from which the message is received. In one such embodiment, for example, an access protocol lookup table may be maintained by the premises gateway, where the access protocol lookup table maintains associations between the user devices served by the premises gateway and the respective access protocols used by the user devices (e.g., UD1 uses MGCP, UD2 uses H.248, and so on).

In one embodiment, the access protocol of the received message may be identified by processing the received message. In one such embodiment, for example, the premises gateway may include logic which may be used to identify the access protocol of the received message. For example, the premises gateway may parse the header(s) of the received message (e.g., in order to identify specific header fields which may be used to identify the access protocol according to which the message is formatted).

For example, the premises gateway may parse the header of the received message looking for a specific field which is only included in MGCP messages. If the field is found, the premises gateway may then conclude that the received message is formatted according to MGCP. If the field is not found the premises gateway may then continue parsing the header looking for another field or combination of fields by which the premises gateway may identify the access protocol according to which the received message is formatted.

Although primarily depicted and described with respect to identifying an access protocol by parsing the header(s) of the received message for one or more specific fields, the premise gateway may include logic adapted for using various other characteristics of the received message in order to identify the access protocol according to which the received message is formatted. For example, the premises gateway may use characteristics such as the size of the message, the length of the message header or lengths of one or more header fields, and the like, as well as various combinations thereof.

In one further embodiment, in which one or more user devices may support multiple access protocols, a combination of the access protocol lookup table and the message processing techniques (or, alternatively, simply the message processing technique) may be used in order to identify the access protocol according to which the received message is formatted. The access protocol according to which the received message is formatted may be determined in various other ways.

At step 208, the received message is translated from being formatted according to the access protocol to being formatted according to a network protocol. In one embodiment, the network protocol is SIP. In one embodiment, the network protocol is a version of SIP implemented in the core IMS network (denoted herein as a normalized version of SIP). Although primarily depicted and described with respect to using SIP as the network protocol, the network protocol may be any protocol capable of supporting communications between components of a core IP network.

The received message is translated from being formatted according to the access protocol to being formatted according to a network protocol in a manner for preserving, in the translated message formatted according to the network protocol, the information conveyed by the received message. The received message may be translated from being formatted according to the access protocol to being formatted according to a network protocol in any manner for converting messages between protocols.

In one embodiment, the received message is translated from being formatted according to the access protocol to being formatted according to the network protocol by reading the message header(s) of the received message and rewriting the message header(s) according to the network protocol. In one embodiment, the premises gateway may map message header(s) of the received message to message header(s) supported by the network protocol (which may include mapping message header fields of the received message to message header fields supported by the network protocol).

The premises gateway may include logic for mapping header(s) of each of the supported access protocols to header(s) of the network protocol. For example, the premises gateway may include logic for mapping H.248 message header fields to SIP message header fields, mapping MGCP message header fields to SIP message header fields, and so on, for any combination of access protocols and network protocol(s) supported by the premises gateway.

At step 210, the translated message (i.e., the version of the message formatted according to the network protocol) is propagated toward the core IMS network. The translated message is propagated toward the core IMS network using the network protocol. At step 212, method 200 ends.

FIG. 3 depicts a method according to one embodiment of the present invention. Specifically, method 300 of FIG. 3 includes a method for translating a message from a network protocol to an access protocol. Although depicted and described as being performed serially, at least a portion of the steps of method 300 of FIG. 3 may be performed contemporaneously, or in a different order than depicted and described with respect to FIG. 3. The method 300 begins at step 302 and proceeds to step 304.

At step 304, a message is received. The message is received at a premises gateway from a component of a core IMS network. The received message is formatted according to a network protocol. In one embodiment, the network protocol is SIP. In one embodiment, the network protocol is a version of SIP implemented in the core IMS network (denoted herein as a normalized version of SIP). Although primarily depicted and described with respect to using SIP as the network protocol, the network protocol may be any protocol capable of supporting communications between components of a core IP network.

At step 306, the user device for which the received message is intended is identified. The user device for which the received message is intended may be identified in any manner. In one embodiment, for example, the user device for which the received message is intended is identified from one or more header fields of the received message.

At step 308, the access protocol used by the intended user device is identified. The access protocol may be any access protocol, such as Megaco/H.248, SGCP, SCCP, MGCP, proprietary versions of SIP, proprietary versions of HTTP, and the like. The access protocol used by the intended user device may be identified in a number of ways.

In one embodiment, the access protocol used by the intended user device may be identified using an access protocol lookup table maintained by the premises gateway, where the access protocol lookup table maintains associations between the user devices served by the premises gateway and the respective access protocols used by the user devices (e.g., UD1 uses MGCP, UD2 uses H.248, and so on).

In one embodiment, the premises gateway may maintain records of messages initiated from user devices served by the premises gateway and propagated to the core IMS network. In one such embodiment, in which the message received at the premises gateway from the core IMS network is a response to an original message initiated from one of the user devices served by the premises gateway, the premises gateway may maintain (e.g., as part of the record of the original message) a record of the access protocol used by the user device to provide the original message to the premises gateway. In such embodiments, the premises gateway identify the access protocol used by the identified user device by accessing the record of the original message in order to identify access protocol used by the user device to provide the original message to the premises gateway.

At step 310, the received message is translated from being formatted according to the network protocol to being formatted according to the identified access protocol.

The received message is translated from being formatted according to the network protocol to being formatted according to the identified access protocol in a manner for preserving, in the translated message formatted according to the access protocol, at least some of the information conveyed by the received message (e.g., in one embodiment, at least a portion of the information included in the received message is not included in the translated message). The received message may be translated from being formatted according to the network protocol to being formatted according to the access protocol in any manner for converting messages between protocols.

In one embodiment, the received message is translated from being formatted according to the network protocol to being formatted according to the access protocol by reading the message header(s) of the received message and rewriting the message header(s) according to the access protocol. In one embodiment, the premises gateway may map message header(s) of the received message to message header(s) supported by the access protocol (which may include mapping message header fields of the received message to message header fields supported by the access protocol).

The premises gateway may include logic for mapping header(s) of the network protocol to header(s) of each of the supported access protocols. For example, the premises gateway may include logic for mapping SIP message header fields to H.248 message header fields, MGCP message header fields, and so on, for any combination of network protocol(s) and access protocol(s) supported by the premises gateway.

In one embodiment, the received message is translated from being formatted according to the network protocol to being formatted according to the access protocol in a secure manner. In one embodiment, the received message is translated from being formatted according to the network protocol to being formatted according to the access protocol in a manner that hides core IMS network information from the user devices served by the premises gateway.

In one such embodiment, for example, protocol translation is performed in a manner that hides addressing and port numbering of core IMS network components from user devices served by the premises gateway. For example, during message translation, address(es) and port number(s) of core IMS network components are omitted from the header(s) of the translated message. Although primarily depicted and described with respect to hiding addressing and port numbering, less or more information may be hidden. This prevents user devices served by the premises gateway from having visibility into the core IMS network.

At step 312, the translated message (i.e., the version of the message formatted according to the access protocol) is propagated toward the intended user device). The translated message is propagated toward the intended user device using the network protocol. At step 314, method 300 ends.

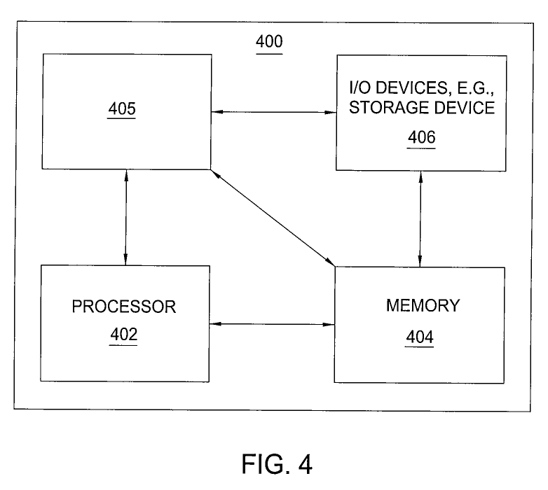

FIG. 4 depicts a high-level block diagram of a general-purpose computer suitable for use in performing the functions described herein. As depicted in FIG. 4, system 400 comprises a processor element 402 (e.g., a CPU), a memory 404, e.g., random access memory (RAM) and/or read only memory (ROM), a protocol translation module 405, and various input/output devices 406 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present protocol translation process 405 can be loaded into memory 404 and executed by processor 402 to implement the functions as discussed above. As such, protocol translation process 405 (including associated data structures) of the present invention can be stored on a computer readable medium or carrier, e.g., RAM memory, magnetic or optical drive or diskette, and the like.

Although primarily depicted and described herein with respect to providing protocol translation functions for core IMS networks, premises gateways according to the present invention may also provide proxy functions.

For example, where a message(s) received at a premises gateway from a core IMS network is intended for a user device that is currently unavailable, the premises gateway may proxy for the user device until the user device becomes available, at which time the premises gateway will deliver the message(s) to the intended user device.

For example, where a message(s) received at a premises gateway from a user device is intended for a core IMS network, but the core IMS network is currently unavailable (e.g., access to the core IMS network is unavailable), the premises gateway may queue the received message(s) until the core IMS network becomes available, at which time the premises gateway will deliver the message(s) to the core IMS network.

Although primarily depicted and described herein with respect to providing protocol translation functions for core IMS networks, the present invention may be used to provide protocol translation functions for various other types of networks in which multiple access protocols are utilized by user devices and one or more network protocols are utilized in the core network.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for propagating messages to a core IMS network, comprising:
receiving, at a premises gateway, a message from a user device served by the premise gateway, wherein the message is the intended for the core IMS network, wherein the message is formatted according to a first protocol;
identifying the first protocol according to which the received message is formatted;
translating the message from being formatted according to the first protocol to being formatted according to a second protocol; and
propagating the message formatted according to the second protocol toward the core IMS network.

2. The method of claim 1, wherein the first protocol is identified by one of: reading the first message and reading a lookup table stored on the premises gateway.

3. The method of claim 1, wherein translating the message comprises:
reading at least one header of the message; and
rewriting each of the at least one header of the message according to the second protocol.

4. The method of claim 1, wherein the first protocol comprises an access protocol by which the user device communicates with the premises gateway and the second protocol comprises a network protocol supported by the core IMS network.

5. The method of claim 1, wherein the first protocol comprises one of H.248, a Simple Gateway Control Protocol (SGCP), a Skinny Client Control Protocol (SCCP), a Media Gateway Control Protocol (MGCP), and a version of Session Initiation Protocol (SIP), and a version of Hypertext Transfer Protocol HTTP); and wherein the second protocol comprises a normalized Session Initiation Protocol (SIP).

6. An apparatus for propagating messages to a core IMS network, comprising:
means for receiving, at a premises gateway, a message from a user device served by the premise gateway, wherein the message is the intended for the core IMS network, wherein the message is formatted according to a first protocol;
means for identifying the first protocol according to which the received message is formatted;
means for translating the message from being formatted according to the first protocol to being formatted according to a second protocol; and
means for propagating the message formatted according to the second protocol toward the core IMS network.

7. The apparatus of claim 6, wherein the first protocol is identified by one of: reading the first message and reading a lookup table stored on the premises gateway.

8. The apparatus of claim 6, wherein translating the message comprises:
reading at least one header of the message; and
rewriting each of the at least one header of the message according to the second protocol.

9. The apparatus of claim 6, wherein the first protocol comprises an access protocol by which the user device communicates with the premises gateway and the second protocol comprises a network protocol supported by the core IMS network.

10. The apparatus of claim 6, wherein the first protocol comprises one of H.248, a Simple Gateway Control Protocol (SGCP), a Skinny Client Control Protocol (SCCP), a Media Gateway Control Protocol (MGCP), and a version of Session Initiation Protocol (SIP), and a version of Hypertext Transfer Protocol HTTP); and wherein the second protocol comprises a normalized Session Initiation Protocol (SIP).

11. A method for propagating messages from a core IMS network to a user device, comprising:
receiving, at a premises gateway, a message from a component of the core IMS network, wherein the message is intended for a user device served by the premises gateway, wherein the message is formatted according to a first protocol;
identifying a second protocol associated with the user device for which the received message is intended;
translating the message from being formatted according to the first protocol to being formatted according to a second protocol; and
propagating the message formatted according to the second protocol toward the user device.

12. The method of claim 11, wherein the second protocol is identified using a lookup table stored on the premises gateway.

13. The method of claim 11, wherein translating the message comprises:
reading at least one header of the message; and
rewriting each of the at least one header of the message according to the second protocol.

14. The method of claim 11, rewriting each of the at least one header of the message according to the second protocol comprises:
removing, from a header of the message, an address of the component of the core IMS network from which the message is received; and
removing, from the header of the message, a port number of the component of the core IMS network from which the message is received.

15. The method of claim 11, wherein the first protocol comprises a network protocol supported by the core IMS network and the second protocol comprises an access protocol by which the user device communicates with the premises gateway.

16. An apparatus for propagating messages from a core IMS network to a user device, comprising:
means for receiving, at a premises gateway, a message from a component of the core IMS network, wherein the message is intended for a user device served by the premises gateway, wherein the message is formatted according to a first protocol;
means for identifying a second protocol associated with the user device for which the received message is intended;
means for translating the message from being formatted according to the first protocol to being formatted according to a second protocol; and
means for propagating the message formatted according to the second protocol toward the user device.

17. The apparatus of claim 16, wherein the second protocol is identified using a lookup table stored on the premises gateway.

18. The apparatus of claim 16, wherein the means for translating the message comprises:
means for reading at least one header of the message; and
means for rewriting each of the at least one header of the message according to the second protocol.

19. The apparatus of claim 16, wherein the means for rewriting each of the at least one header of the message according to the second protocol comprises:
means for removing, from a header of the message, an address of the component of the core IMS network from which the message is received; and
means for removing, from the header of the message, a port number of the component of the core IMS network from which the message is received.

20. The apparatus of claim 16, wherein the first protocol comprises a network protocol supported by the core IMS network and the second protocol comprises an access protocol by which the user device communicates with the premises gateway.
